(19) United States
(12) Patent Application Publication
(10) Pub. No.: US 2009/0114873 A1
(43) Pub. Date: May 7, 2009

(54) DIAPHRAGM FOR USE WITH CONTROL VALVES

(76) Inventors: Richard Anagnos, Madbury, NH (US); Dennis Eugene O'Hara, Strafford, NH (US); Ernest Souliere, Rochester, NH (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/935,006

(22) Filed: Nov. 5, 2007

(51) Int. Cl. F16K 7/00; F16K 31/126

(52) U.S. Cl. 251/331; 29/890.12

(57) ABSTRACT

A diaphragm for use with a valve includes a body having a central portion including an outer central portion and offset by an angled portion from an outer portion. The central portion is to be disposed at a position adjacent a valve seat and displaced into engagement with the valve seat to affect fluid flow. The body deforms substantially at the outer central portion and angled portion during displacement of the central portion by the valve and reacts substantially unilaterally to prevent vibration of the diaphragm during fluid flow past the valve seat.

### FIELD OF THE DISCLOSURE

This disclosure relates generally to control valves and, more particularly, to a diaphragm for use with control valves.

### BACKGROUND

Processing plants use control valves in a wide variety of applications such as, for example, controlling product flow in a food processing plant, maintaining fluid levels in large tank farms, etc. Automated control valves are used to manage the product flow or to maintain the fluid levels by functioning like a variable passage. The amount of fluid flowing through a valve body of the control valve can be accurately controlled by the movement of a valve control member (e.g., a plug, a diaphragm, etc.). In some control valves (e.g., regulator valves), the movement of the valve control member relative to a valve seat is controlled by one of more spring members located on one or both sides of the valve control member, whereby at least one of the spring members is in the path of the fluid flow. The one or more spring members are used to achieve a predetermined reaction by the diaphragm, and the diaphragm acts merely as a subservient pressure boundary or shut-off membrane. However, new industry standards require that a structure such as, for example, a spring member, not be located in the fluid flow path. A structure located in the fluid flow path can create a potential site for harboring contaminants or organisms.

### SUMMARY

A diaphragm for use with a valve includes a body having a central portion including an outer central portion and substantially offset from an outer rim of the body by an angled portion. The outer rim is configured to be engaged by a housing portion of the valve and the central portion is configured to be disposed at a position adjacent a valve seat. The body deforms substantially at the outer central portion and angled portion during displacement of the central portion by the valve and reacts substantially unilaterally to prevent vibration of the diaphragm during fluid flow past the valve seat.

### BRIEF DESCRIPTION OF THE DRAWINGS

FIG. 1 is a partially cut-away illustration of a known control valve.

FIG. 2 is a partially cut-away illustration taken along line 2-2 of the known control valve of FIG. 1.

FIGS. 3A-C are schematic illustrations of known diaphragms used in valves.

FIG. 4 is partially cut-away illustration of an example control valve.

FIG. 5 is an enlarged illustration of the example indented resilient diaphragm of the example control valve of FIG. 4.

FIG. 6 is an elevation view of the example indented resilient diaphragm of FIG. 5.

FIG. 7 is an enlarged view of the portion of the example indented resilient diaphragm of FIG. 6 encircled by dashed line 7.

FIG. 8 is a representative flow chart of an example method to make the example indented resilient diaphragm of FIGS. 4, 5, 6 and 7.

### DETAILED DESCRIPTION

In general, the example indented resilient diaphragm described herein may be utilized for fluid flow in various types of assemblies or devices. Additionally, while the examples disclosed herein are described in connection with the control of product flow for the processing industry, the examples described herein may be more generally applicable to a variety of control operations for different purposes.

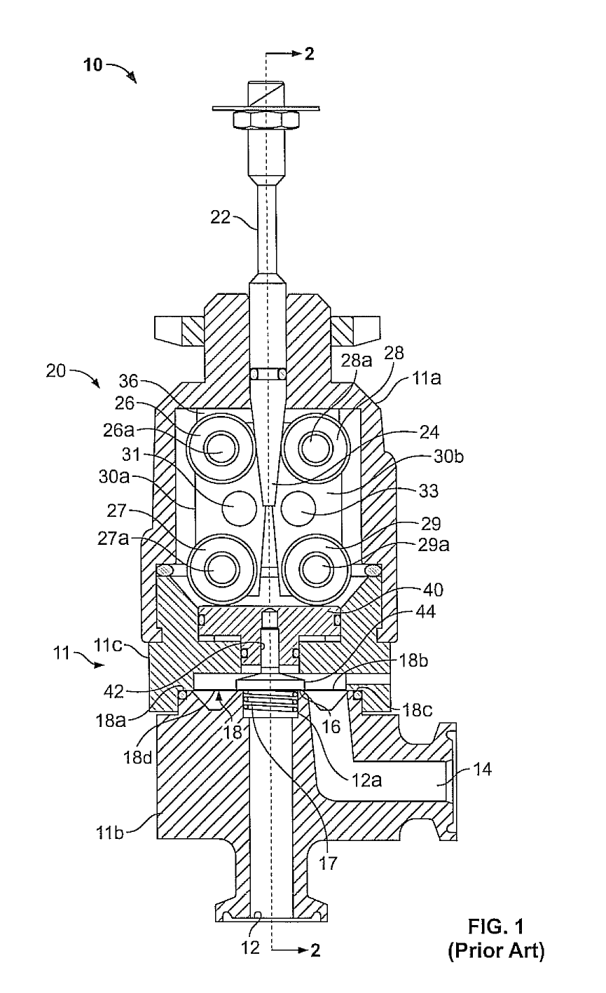

FIG. 1 is a partially cut-away schematic illustration of a known control valve 10. The control valve 10 includes a valve body 11 having body or housing portions 11a, 11b and 11c, an inlet port 12, an outlet port 14, a valve seat 16, a spring 17 located in an inlet recess 12a, a metal diaphragm plate 18, and a force mechanism 20. The diaphragm plate 18 has its outer rim 18a secured or captured between the housing portions 11b and 11c. The spring 17 engages the diaphragm plate 18 to move or deflect the diaphragm plate 18 away from the valve seat 16 into engagement with a plunger 44 to permit fluid flow through the valve seat 16 to the outlet 14. The spring 17 also prevents vacuum or suction vibration of the diaphragm plate 18 against the valve seat 16.

The metal diaphragm plate 18 may include a central portion 18b located between the plunger 44 and the spring 17. The spring 17 forces the central portion 18b of the metal diaphragm plate 18 away from the valve seat 16 to permit fluid flow between the inlet port 12 and the outlet port 14.

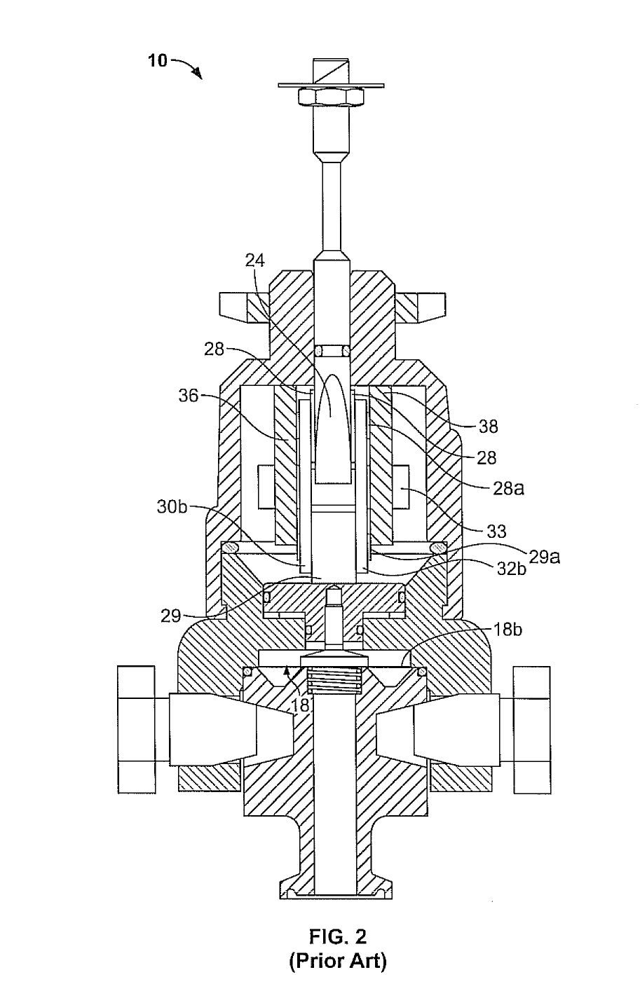

The force mechanism 20 includes a stem 22 having a double-ramped end 24 located between rollers 26 and 28. Referring to FIGS. 1 and 2, the rollers 26 and 28 are mounted on axles 26a and 28a, respectively. The rollers 26 and 28 extend between two sets of inner frames: inner frame 30a (see FIG. 1) and located in front of the inner frame 30a a similar-shaped inner frame that is not shown; and inner frames 30b and 32b (see FIG. 2). The axle 26a extends between the inner frame 30a and the not shown inner frame, and the axle 28a extends between the inner frames 30b and 32b (see FIG. 2). Another pair of rollers 27 and 29 are mounted on axles 27a and 29a, respectively. The rollers 27 and 29 are between the two sets of inner frames: 30a and its not shown inner frame, and 30b, 32b, respectively. The axle 27a extends between the inner frame 30a and the not shown inner frame (see FIG. 1), and the axle 29a extends between the inner frames 30b and 32b (see FIG. 2). The inner frame 30a and the not shown inner frame are mounted pivotally upon an axle 31 and the other set of inner frames 30b and 32b are mounted pivotally upon an axle 33 (see FIG. 2). The axles 31 and 33 are connected to outer frames 36 and 38 (see FIGS. 1 and 2).

The force mechanism 20 further includes a piston 40 engaged by the rollers 27 and 29 located within the valve body 11. The piston 40 has an opening 42 that receives the plunger 44. The plunger 44 is positioned adjacent a side 18c of the diaphragm plate 18. An opposite side 18d of the diaphragm plate 18 is adjacent the valve seat 16 and is engaged by the spring 17.

Referring to FIGS. 1 and 2, the control valve 10 receives fluid through the inlet 12 and the fluid flows past the diaphragm 18 to the outlet 14. When a controller (not shown) determines that fluid flow should cease, the stem 22 is displaced downwardly by another part (not shown) of the force mechanism 20 to displace the double-ramped end 24 downwardly between the rollers 26 and 28. The downward movement of the double-ramped end 24 moves the rollers 26 and 28 away from one another resulting in the inner frame 30a and the not shown inner frame pivoting about the axle 31 and the inner frames 30b and 32b pivoting about the axle 33. This pivoting results in the rollers 27 and 29 being moved toward one another along the arcs of circles having as their centers the centers of the axles 31 and 33, respectively. The movement of the rollers 27 and 29 displaces downwardly the piston 42 and the plunger 44 so that the plunger 44 displaces the diaphragm plate 18 against the spring 17 and into engagement with the valve seat 16 to prevent fluid flow to the outlet 14. The diaphragm plate 18 is deformed by the downward movement of the plunger 44. The diaphragm plate 18 is displaced easily and acts as a subservient or free-floating shut-off membrane that engages and closes the valve seat 16. When the controller determines that the fluid flow should resume, the force mechanism 20 retracts the plunger 44 and the spring 17 forces the diaphragm 18 away from the valve seat 16. During fluid flow past the valve seat 16, the spring 17 prevents downward movement, as a result of fluid pressure or vacuum suction, of the central portion 18b toward the valve seat 16, thereby preventing vibration or hammering by the diaphragm plate 18.

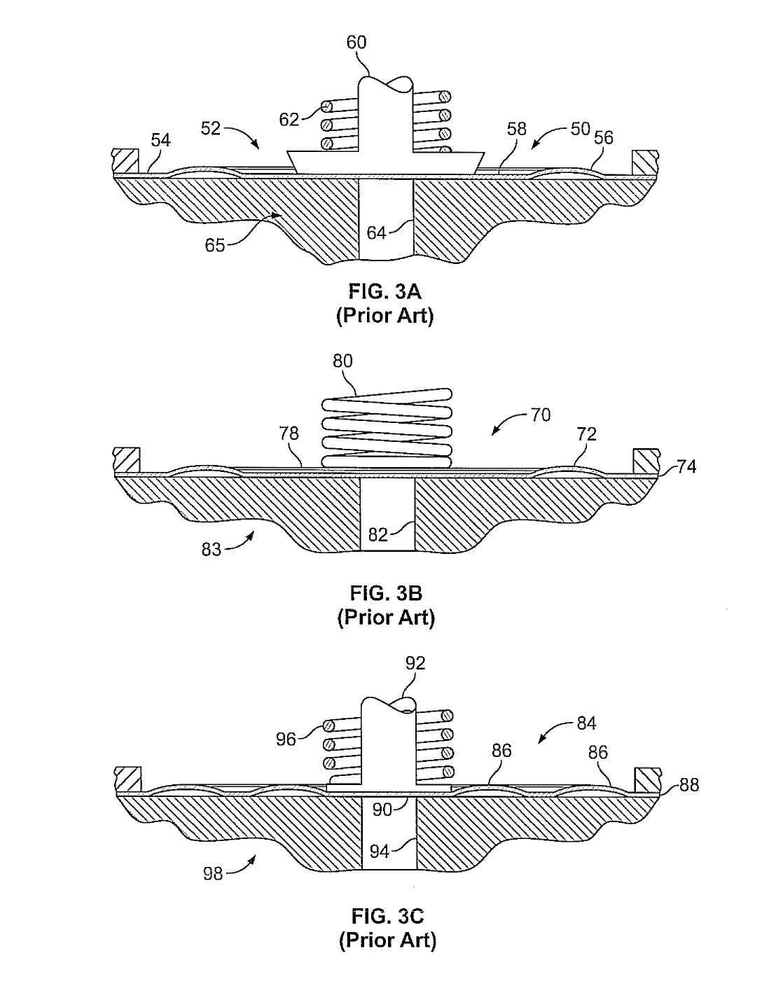

FIGS. 3A-C are schematic illustrations of known diaphragms used in valves. In FIG. 3A, a diaphragm 50 includes an indented section 52 displaced slightly relative to an outer circumference 54. The section 52 includes a bowed or curved portion 56 located radially inwardly of the outer circumference 54, and the bowed or curved portion 56 extends to a flat central portion 58 located closely adjacent a horizontal plane containing the outer circumference 54. The diaphragm 50 is engaged by a plunger 60 forced toward a valve passage 64 by a spring 62 in a valve 65. The valve passage 64 is located on the other side of the central portion 58 of the diaphragm 50. The diaphragm 50 is free-floating and reacts to media pressure and the movement of the plunger 60 during the flow of media through the valve passage 64.

FIG. 3B is another schematic illustration of known diaphragm 70 used in a valve 83. In FIG. 3B, the diaphragm 70 includes an indented section 72 radially inwardly of an outer circumference 74. The indented section 72 is bowed or curved and located radially between the outer circumference 74 and a flat central portion 78 engaged by a spring 80. A valve passage 82 of a valve 83 is located on the other side of the central portion 78 of the diaphragm 70. The diaphragm 70 is free-floating and reacts to media pressure and the force of the spring 80 during the flow of media through the valve passage 82.

FIG. 3C is another schematic illustration of known diaphragm 84 used in a valve 98. In FIG. 3C, the diaphragm 84 includes indented or bowed sections 86 radially inwardly of an outer circumference 88. The indented or bowed sections 86 are located radially between the outer circumference 88 and a flat central portion 90. The diaphragm 84 is engaged by a plunger 92 forced toward a valve passage 94 by a spring 96 in the valve 98. The diaphragm 84 is free-floating and subservient to media pressure and the force of the plunger 92 during the flow of media through the valve passage 94.

Recent changes in standards applicable to control valves require that a structure such as, for example, the spring 17 in FIGS. 1 and 2, should not be located in the flow path of fluid. The presence of such a structure in the flow path of the fluid can be a potential site for harboring contaminants or organisms. Thus, it is highly desirable to provide a control valve that does not require components, such as springs, in the flow path of the fluid.

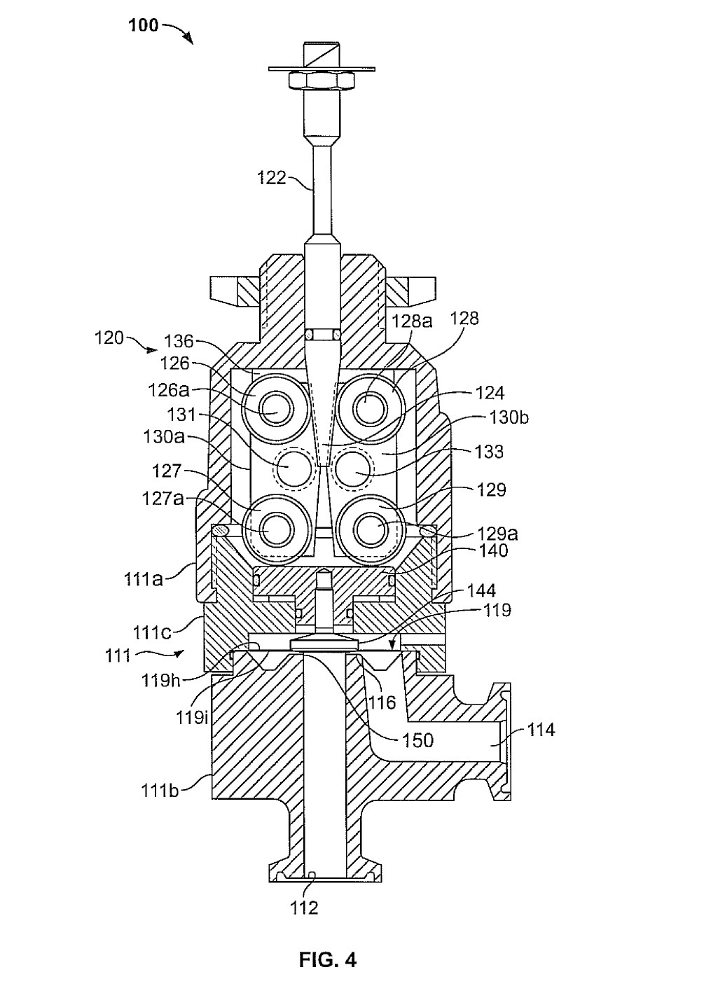

FIG. 4 is partially cut-away illustration of an example control valve 100. Some elements of the example control valve 100 of FIG. 4 are substantially the same as elements shown and described in connection with the control valve of FIGS. 1 and 2. Thus, in the interest of brevity, the description of the elements that are the same as the elements in FIGS. 1 and 2 will not be repeated. Instead, the interested reader is referred back to the corresponding description of FIGS. 1 and 2. To facilitate this process, similar elements in FIG. 4 have been numbered with reference numerals increased by 100 above the corresponding elements in FIG. 1.

In FIG. 4, the example control valve 100 includes a valve body 111 having body or housing portions 111a, 111b and 111c, an inlet port 112, an outlet port 114, a valve seat 116, an example indented resilient diaphragm 119, and a force mechanism 120. The force mechanism 120 includes a stem 122, a double-ramped end 124, rollers 126, 128 and 127, 129, an inner frame 130a and in front of it in FIG. 4 a similar-shaped inner frame that is not shown, inner frame 130b and in front of it a similar-shaped inner frame that is not shown, axles 126a, 128a, 127a, 129a, 131 and 133, outer frame 136 and in front of it in FIG. 4 a similar-shaped outer frame that is not shown, a piston 140, and a plunger 144. The valve seat 116 includes a nozzle angle 150 of approximately 15 degrees to improve fluid flow past the valve seat 116.

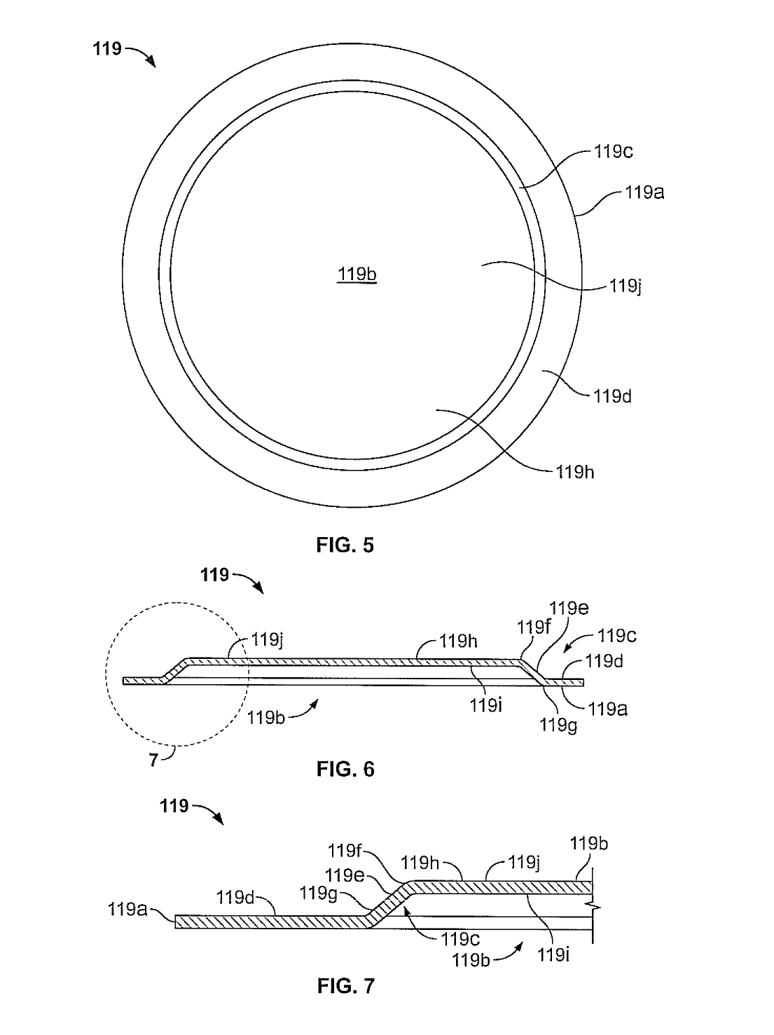

In FIG. 4, the plunger 144 engages the example indented resilient diaphragm 119. Referring to the enlarged illustrations of the example indented resilient diaphragm 119 in FIGS. 5, 6 and 7, the example indented resilient diaphragm 119 includes a disc-shaped metallic body 119a having an offset central portion 119b extending to a radially outer central portion 119j and an outer angled section or portion 119c extending into a wide outer or circumferential portion or rim 119d. The angled portion 119c includes a straight or flat section 119e located between two corners 119f and 119g. The central portion 119b is offset substantially from the wide circumferential portion 119d (e.g., a diaphragm having a material thickness of approximately 0.20 mm, a diaphragm diameter of approximately 41 mm, and a central portion offset approximately 0.6 mm from an outer rim of the diaphragm). The example indented resilient diaphragm 119 may be made of various resilient materials such as, for example, Hastelloy C (a nickel-based alloy), 316L stainless steel, alloys, plastic, fiber-reinforced polytetrafluoroethylene, or other metals. As an illustrative example, the indented resilient diaphragm 119 is illustrated as metallic and disc-shaped. The example indented resilient diaphragm 119 has a side 119h positioned in engagement with the plunger 144 of the force mechanism 120 and a side 119i positioned adjacent or spaced-apart from the valve seat 116 (see FIG. 4). When the stem 122 is in a retracted position as shown in FIG. 4, the control valve 100 permits fluid to flow from the inlet port 112 to the outlet port 114. A radially outermost part of the circumferential portion or rim 119d is secured between housing portions 111b and 111c.

The example indented resilient diaphragm 119 of FIGS. 4-7 is manufactured by a process that produces the disc-shaped metallic body 119a which retains it springiness or resistance (e.g., spring rate) to deformation. A pre-polished sheet of flexible metal such as, for example, 316L stainless steel, may be provided for a forming or stamping operation. Optionally, the sheet of metal may be pre-polished on only the side 119i for engagement with the valve seat 116, and/or the sheet of metal can be cut in a desired form (e.g., a circular form) prior to the forming or stamping operation. The stamping operation displaces the central portion 119b to create the outer angled section 119c such that the central portion 119b is offset substantially relative to the outer or circumferential portion 119d. When the central portion 119b is displaced by the plunger 144 of the example control valve 100, the example indented diaphragm 119 deforms substantially at the outer central portion 119j and the angled portion 119c. The example indented diaphragm 119 has two zones of flexibility: the central portion 119b and the outer central portion 119j and angled portion 119c. Thus, the example indented diaphragm 119 retains its springiness or spring rate. The example indented resilient diaphragm 119 has a generally hat-shaped configuration.

The example indented resilient diaphragm 119 has an effective spring rate to prevent vibration or hammering by the diaphragm 119 during fluid flow past the valve seat 116, and to achieve increased service cycles. As previously described herein, the metal diaphragm plate 18 in FIGS. 1 and 2 requires that a spring 17 engage the plate 18 to both move and retain the diaphragm plate 18 away from the valve seat 16. However, the example indented resilient diaphragm 119 has an effective spring rate that eliminates the need for a resilient member or device such as, for example, a spring. The example indented resilient diaphragm 119 is able to achieve unilaterally (i.e., by itself) the prevention of movement or vibration that results in hammering. For example, the example indented resilient diaphragm 119 may have a diameter of ½ inch and a spring rate of 400 pounds/inch.

In FIG. 4, the control valve 100 receives fluid through the inlet 112 and the fluid flows through the valve seat 116 and past the adjacent example indented resilient diaphragm 119 to the outlet 114. When a controller (not shown) determines that fluid flow should cease, the force mechanism 120 moves the plunger 144 downwardly to displace or deflect the example indented resilient diaphragm 119 into engagement with the valve seat 116 to prevent fluid flow to the outlet 114. The example indented diaphragm 119 deforms substantially at the outer central portion 119j and angled portion 119c so that during deformation the disc-shaped metallic body 119a is under stress. When the controller determines that fluid flow should resume through the example control valve 100, the actuator 120 retracts the plunger 144 and the example indented resilient diaphragm 119 moves away from the valve seat 116 to permit fluid flow to the outlet 114. The example indented resilient diaphragm 119 remains adjacent the valve member 116 so that fluid may continue to flow past the diaphragm 119 until the controller again determines that fluid flow should cease. However, as the fluid flows through the valve seat 116, the diaphragm 119 substantially unilaterally, through its effective spring rate, prevents movement or vibration that could result in hammering.

The example indented resilient diaphragm 119 of the example control valve 100 provides a robust valve control member. Testing of the indented resilient diaphragm 119 has achieved an improved cycle life (i.e., a number of cycles several times greater than achieved by a diaphragm plate such as the diaphragm plate 18 in FIGS. 1 and 2). The diaphragm plate 18 in FIGS. 1 and 2 requires engagement by the spring 17 to prevent vacuum or suction vibration at the valve seat 16. However, the example indented resilient diaphragm 119 in FIGS. 4-7 has not shown sensitivity to vacuum or suction vibration at the valve seat 116. The use of the indented resilient diaphragm 119 did not result in the inducement of noise at low pressure closure points of the example control valve 100, a problem that may occur in the known control valve 10 of FIGS. 1 and 2 due to the vibration by the diaphragm plate 18 at the valve seat 16. Additionally, the example control valve 100 provides an improved flow of fluid at a pressure drop between the inlet 112 and the outlet 114. In the control valve 10 of FIGS. 1 and 2, the valve coefficient (Cv) is about 0.7, while in FIG. 4 the removal of the spring 17 increases the Cv to about 0.8 in an example control valve. The elimination of the inlet recess 12a in FIGS. 1 and 2 and the addition of the nozzle angle 150 of about 15 degrees as shown in FIG. 4 can further increase the Cv to about 1.0 in the example control valve 100. It is foreseeable that the nozzle angle 150 may comprise other magnitudes of degrees that are optimal for associated example control valves.

Control valves may be used to control the flow of steam or erosive fluids. Steam or erosive fluids can deteriorate the surface of the indented resilient diaphragm 119. To prevent erosion and/or extend the service life (e.g., wear life) of the indented resilient diaphragm 119, an alloy may be added to the side 119i to thicken the central portion 119b where it engages the valve seat 116. For example, metal alloys, ceramics, or polymers may be used to coat the side 119i of the indented resilient diaphragm 119.

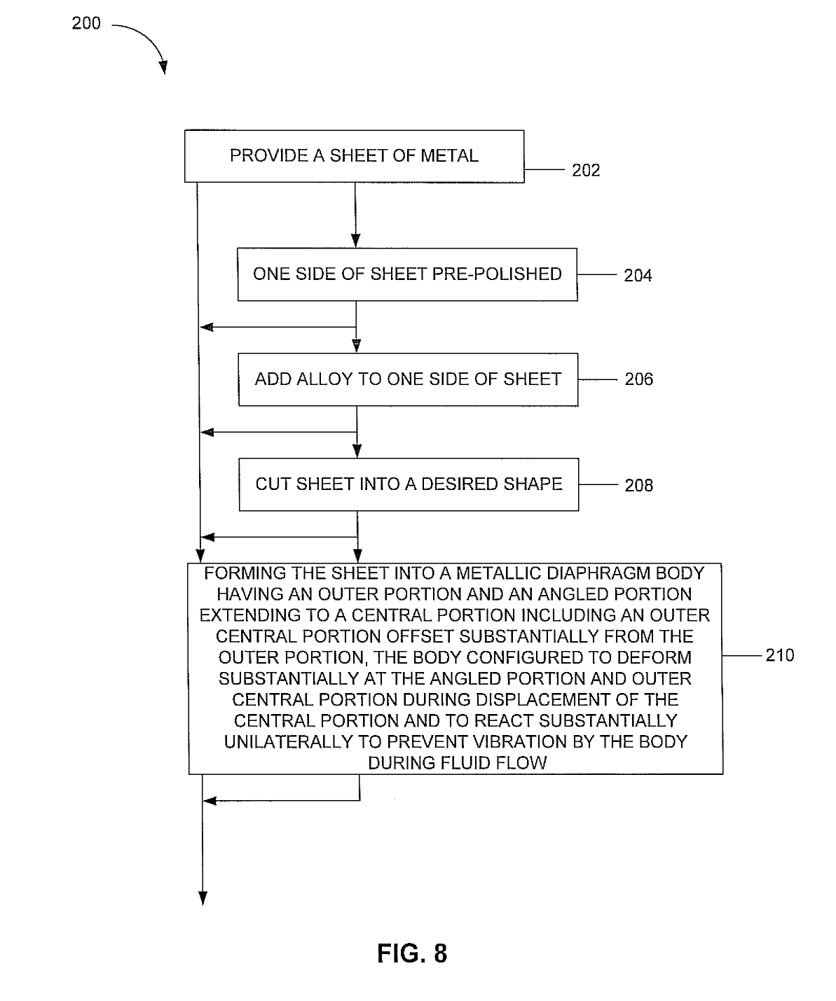

FIG. 8 is a representative flow chart of an example process or method 200 to make a metallic diaphragm for use with a control valve. Initially at block 202 of the example method 200, a sheet of metal is provided. The method 200 includes several options at blocks 204, 206 and 208. At block 204, at least one side of the sheet of metal (e.g., the side 119i of the example indented resilient diaphragm 119 in FIGS. 4-7) may be pre-polished. Optionally, an alloy may be added to one side of the sheet of metal (e.g., the side 119i of the example indented resilient diaphragm 119 in FIGS. 4-7), (block 206). And at block 208, the sheet of metal may be cut into a desired shape such as, for example, circular or oval (e.g., the metallic body 119a in FIGS. 4-7). The sheet of metal is then formed into a metallic diaphragm body (e.g., the metallic body 119a in FIGS. 4-7) having an outer portion (e.g., the outer or circumferential portion 19d of the example indented resilient diaphragm 119 in FIGS. 4-7) and an angled section (e.g., the outer angled section 119c in FIGS. 5-7) extending to a central portion (e.g., the central portion 119b in FIGS. 5-7) including an outer central portion (e.g., the radially outer central portion 119j in FIGS. 5-7) offset substantially from the outer portion (e.g., the outer or circumferential portion 119d), the body (e.g., the metallic body 119a in FIGS. 5-7) configured to deform substantially at the angled portion (e.g., the angled portion 119c) and outer central portion (e.g., the radially outer central portion 119j) during displacement of the central portion (e.g., the central portion 119b) and to react substantially unilaterally to prevent vibration by the body (e.g., the metallic body 119a) during fluid flow, (block 210).

Although certain example apparatus, methods, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A diaphragm for use with a valve, comprising:
a body having a central portion including an outer central portion and substantially offset from an outer rim of the body by an angled portion, the outer rim configured to be engaged by a housing portion of the valve and the central portion configured to be disposed at a position adjacent a valve seat, the body to deform substantially at the outer central portion and angled portion during displacement of the central portion by the valve and to react substantially unilaterally to prevent vibration of the diaphragm during fluid flow past the valve seat.

2. A diaphragm as defined in claim 1, wherein the body has a spring rate to counteract fluid pressure and prevent vibration of the body.

3. A diaphragm as defined in claim 1, wherein the angled portion includes a straight section extending between a corner at the outer rim and a corner at the outer central portion.

4. A diaphragm as defined in claim 1, wherein the body is made of steel.

5. A diaphragm as defined in claim 1, wherein the body is made of at least one of a nickel-based alloy, plastic, or polytetrafluoroethylene.

6. A diaphragm as defined in claim 1, wherein the body is disc-shaped.

7. A diaphragm as defined in claim 1, wherein the central portion includes at least one of an alloy, ceramic, polymer or metal to provide at least one of wear resistance or corrosion resistance.

8. A control valve, comprising:
a housing having a housing portion;
a valve seat through which fluid may flow;
a body having a central portion including an outer central portion and substantially offset from an outer rim of the body by an angled portion, the outer portion engaged by the housing portion of the control valve and the central portion disposed adjacent the valve seat; and
a force mechanism to displace the central portion of the body into engagement with the valve seat, wherein the body deforms substantially at the outer central portion and angled portion during displacement of the central portion by the force mechanism and reacts substantially unilaterally to prevent vibration of the diaphragm during fluid flow past the valve seat.

9. A control valve as defined in claim 8, wherein the angled portion includes a straight section extending between a corner at the outer rim and a corner at the outer central portion.

10. A control valve as defined in claim 8, wherein the body has a spring rate to counteract fluid pressure and prevent vibration of the body.

11. A control valve as defined in claim 8, wherein the valve seat includes a nozzle angle of approximately 15 degrees.

12. A control valve as defined in claim 8, wherein the body is made of at least one of a nickel-based alloy, plastic, or polytetrafluoroethylene.

13. A diaphragm for use with a valve, comprising:
a disc-shaped body having at least two zones of flexibility comprising a central portion and an outer central portion extending to an angled portion, the central portion and outer central portion substantially offset from a circumferential portion of the disc-shaped body, the circumferential portion configured to be engaged by a housing portion of the valve and the angled portion including a flat section extending between a corner at the circumferential portion and a corner at the outer central portion, the disc-shaped body to deform substantially at the outer central portion and angled portion during displacement of the central portion by the valve and to react substantially unilaterally to prevent vibration of the diaphragm during fluid flow past a valve seat of the valve.

14. A diaphragm as defined in claim 13, wherein the central portion includes at least one of an alloy, ceramic, polymer or metal to provide at least one of wear resistance or corrosion resistance.

15. A diaphragm as defined in claim 13, wherein the body is made of at least one of a nickel-based alloy, plastic, or polytetrafluoroethylene.

16. A valve, comprising:
a housing having a housing portion;
a valve seat;
a disc-shaped metallic body having at least two zones of flexibility comprising a central portion and an outer central portion extending to an angled portion, the central portion and outer central portion substantially offset from a circumferential portion of the disc-shaped metallic body, the circumferential portion engaged by a housing portion of the valve and the angled portion including a straight section extending between a corner at the circumferential portion and a corner at the outer central portion; and
a force mechanism to displace the central portion of the disc-shaped metallic body into engagement with the valve seat, wherein the disc-shaped metallic body deforms substantially at the outer central portion and angled portion during displacement of the central portion by the force mechanism and reacts substantially unilaterally to prevent vibration of the diaphragm during fluid flow past the valve seat.

17. A valve as defined in claim 16, wherein the central portion includes at least one of an alloy, ceramic, polymer or metal to provide at least one of wear resistance or corrosion resistance.

18. A valve as defined in claim 16, wherein the body has a spring rate to counteract fluid pressure and prevent vibration of the body.

19. A valve as defined in claim 16, wherein the body is made of at least one of a nickel-based alloy, plastic, or polytetrafluoroethylene.

20. A valve as defined in claim 16, wherein the valve seat includes a nozzle angle of approximately 15 degrees.

21. A method to make a diaphragm for use with a control valve, comprising:
providing a sheet of metal;
forming the sheet of metal into a metallic diaphragm body having an outer portion and an angled portion extending to a central portion including an outer central portion offset substantially from the outer portion, the body configured to deform substantially at the angled portion and outer central portion during displacement of the central portion by the control valve and to react substantially unilaterally to prevent vibration by the body during fluid flow past the valve seat.

22. A method as defined in claim 21, wherein the sheet of metal has at least one pre-polished side.

23. A method as defined in claim 21, further comprising adding a material to the diaphragm to provide at least one of wear-resistance or corrosion resistance.

24. A method as defined in claim 21, further comprising cutting the sheet of metal into at least one of a circular or an oval shape prior to the forming.

25. A method as defined in claim 21, wherein the metallic diaphragm body is generally circular and hat-shaped.
